(19) United States
(12) Patent Application Publication
(10) Pub. No.: US 2026/0280318 A1
(43) Pub. Date: Sep. 17, 2026

(54) POWER SUPPLY CIRCUIT AND MOVING OBJECT

(71) Applicant: HONDA MOTOR CO., LTD., Tokyo (JP)

(72) Inventor: Manabu Mitani, Wako-shi (JP)

(21) Appl. No.: 19/563,180

(22) Filed: Mar. 11, 2026

(30) Foreign Application Priority Data
Mar. 13, 2025 (JP) 2025-039914

(51) Int. Cl. H02J 7/60; B60L 3/00; B60L 50/15; H02J 7/34

(52) U.S. Cl. CPC H02J 7/663; B60L 3/0046; B60L 50/15; H02J 7/34; B60L 2200/10

(57) ABSTRACT

A power supply circuit includes a first power transmission bus that supplies direct current power from a power generation device to a first load device, a first disconnection device including a first disconnection unit disposed in a positive wire of the first power transmission bus, a first reverse flow prevention device having a first reverse flow prevention element disposed in the positive wire of the first power transmission bus, a charging circuit that is connected to the first power transmission bus between the first disconnection device and the first reverse flow prevention device and to which an external charging device can be connected, and a second disconnection device having a second disconnection unit provided in a negative wire of the charging circuit.

### CROSS-REFERENCE TO RELATED APPLICATIONS

This application is based upon and claims the benefit of priority from Japanese Patent Application No. 2025-039914 filed on March 13, 2025, the contents of which are incorporated herein by reference.

### BACKGROUND OF THE INVENTION

### FIELD OF THE INVENTION

The present disclosure relates to a power supply circuit and a moving object.

### DESCRIPTION OF THE RELATED ART

JP 2023-124915 A discloses a power supply circuit having a charging circuit that can be connected to a charging device provided outside an aircraft.

### SUMMARY OF THE INVENTION

There is a desire for a more satisfactory power supply circuit and the like.

The present disclosure has the object of solving the aforementioned problem.

A first aspect of the present disclosure is characterized by a power supply circuit including: a first power transmission bus configured to supply, to a first load device, direct current power output from a power generation device and direct current power output from a first power storage device provided in parallel with the power generation device; a first disconnection device configured to disconnect the power generation device from the first power transmission bus by a first disconnection unit disposed in only one of a pair of wires composed of a positive wire and a negative wire of the first power transmission bus, a first reverse flow prevention device configured to prevent power from being supplied from the first power storage device to the first power generation device by a first reverse flow prevention element disposed in only the one of the pair of wires of the first power transmission bus; a charging circuit having one end connected to the first power transmission bus at a position between the first disconnection device and the first reverse flow prevention device and another end connected to a charging port connectable to an external charging device; and a second disconnection device configured to disconnect the charging port from the first power transmission bus by a second disconnection unit disposed in only one of a pair of wires composed of a positive wire and a negative wire of the charging circuit, wherein the one of the pair of wires of the charging circuit in which the second disconnection unit is disposed is connected to another of the pair of wires of the first power transmission bus that is different from the one of the pair of wires of the first power transmission bus in which the first disconnection unit and the first reverse flow prevention element are disposed.

A second aspect of the present disclosure is characterized by a moving object equipped with the power supply circuit according to the first aspect.

In accordance with the present disclosure, it is possible to provide a more satisfactory power supply circuit.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram of a moving object according to one embodiment;

FIG. 2 is a schematic diagram of a power supply system according to the one embodiment;

FIG. 3 is a schematic diagram of a power supply system according to a first comparative example;

FIG. 4 is a schematic diagram of a power supply system according to a second comparative example;

FIG. 5 is a diagram for explaining a function of disconnecting a charging port of a power supply circuit according to the one embodiment;

FIG. 6 is a diagram for explaining the function of disconnecting the charging port of the power supply circuit according to the one embodiment;

FIG. 7 is a diagram for explaining the function of disconnecting the charging port of the power supply circuit according to the embodiment;

FIG. 8 is a diagram for explaining the function of disconnecting the charging port of the power supply circuit according to the one embodiment;

FIG. 9 is a diagram for explaining the function of disconnecting the charging port of the power supply circuit according to the one embodiment;

FIG. 10 is a diagram for explaining the function of disconnecting the charging port of the power supply circuit according to the one embodiment;

FIG. 11 is a diagram for explaining the function of disconnecting the charging port of the power supply circuit according to the one embodiment;

FIG. 12 is a diagram for explaining the function of disconnecting the charging port of the power supply circuit according to the one embodiment;

FIG. 13 is a diagram for explaining the function of disconnecting the charging port of the power supply circuit according to the one embodiment;

FIG. 14 is a diagram for explaining the function of disconnecting the charging port of a power supply circuit according to the one embodiment;

FIG. 15 is a diagram for explaining the function of disconnecting the charging port of the power supply circuit according to the one embodiment;

FIG. 16 is a diagram for explaining the function of disconnecting the charging port of the power supply circuit according to the one embodiment;

FIG. 17 is a diagram for explaining the function of disconnecting the charging port of the power supply circuit according to the one embodiment;

FIG. 18 is a diagram for explaining the function of disconnecting the charging port of the power supply circuit according to the embodiment;

FIG. 19 is a diagram for explaining the function of disconnecting the charging port of the power supply circuit according to the one embodiment;

FIG. 20 is a diagram for explaining the function of disconnecting the charging port of the power supply circuit according to the one embodiment; and

FIG. 21 is a diagram for explaining the function of disconnecting the charging port of the power supply circuit according to the one embodiment.

### DETAILED DESCRIPTION OF THE INVENTION

A moving object, which is an electric vertical takeoff and landing aircraft (eVTOL aircraft), includes, as a power source, a power generation device having a generator driven by an engine, and a power storage device having a battery. When the moving object is on the ground, the power storage device can be charged with power of an external charging device.

The moving object is equipped with a power supply circuit having a power transmission bus capable of supplying, to a load device, direct current power output from a power generation device and direct current power output from a power storage device provided in parallel with the power generation device. A charging circuit provided with a charging port to which an external charging device can be connected is connected to the power transmission bus.

The power generation device and the load device each have a smoothing capacitor, and the smoothing capacitor may store electrical charge at the time when the external charging device is connected to the charging circuit. In the case where the external charging device is connected to the charging port, the electrical connection between the charging port and the power transmission bus is disconnected by the disconnection device provided in the charging circuit. In this manner, a current is prevented from flowing between the smoothing capacitors of the power generation device and the load device and the charging port.

However, since the power supply circuit is provided with a large number of disconnection devices, there are problems of increases in weight, size, and cost of the power supply circuit due to the disconnection devices.

The power supply circuit of the present disclosure can suppress increases in weight, size, and cost.

### Embodiment

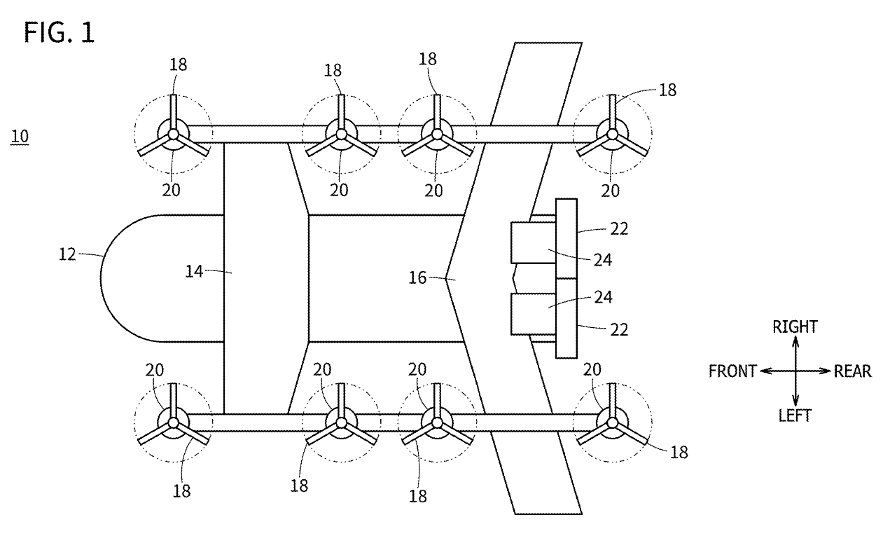

Configuration of Moving Object FIG. 1 is a schematic diagram of a moving object 10 according to one embodiment. The moving object 10 of the one embodiment is an electric vertical takeoff and landing aircraft (eVTOL aircraft). The moving object 10 includes a fuselage 12. A cockpit, a cabin, and the like are provided in the fuselage 12. A pilot rides in the cockpit and steers the moving object 10. A passenger or the like rides in the cabin. The moving object 10 may be automatically operated.

The moving object 10 has a front wing 14 and a rear wing 16. In the case that the moving object 10 moves in a forward direction, lift is generated on each of the front wing 14 and the rear wing 16.

The moving object 10 includes eight VTOL rotors 18 and two cruise rotors 22. One VTOL electric motor 20 is provided for one VTOL rotor 18. The VTOL electric motors 20 are single three-phase motors. One cruise electric motor 24 is provided for one cruise rotor 22. The cruise electric motors 24 are double three-phase motors.

### Configuration of Power Supply System

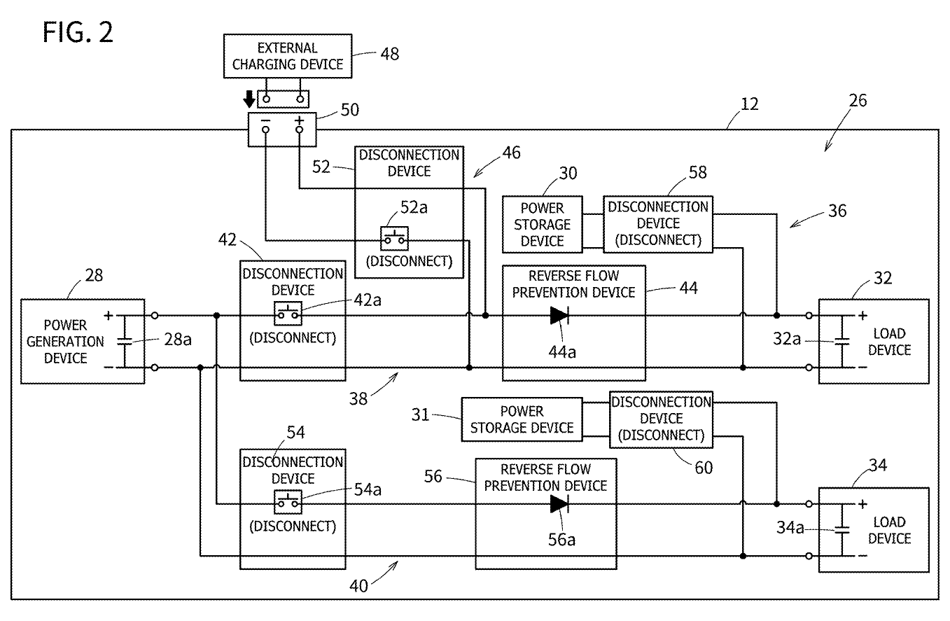

FIG. 2 is a schematic diagram of a power supply system 26 according to the embodiment. The power supply system 26 is mounted in the moving object 10.

The power supply system 26 includes a power generation device 28 as a main power source. The power generation device 28 includes an engine, an electrical power generator, and a power drive unit (hereinafter referred to as a PDU), none of which is illustrated. The engine, for example, is a gas turbine engine. The engine may be a reciprocating engine instead of a gas turbine engine. The electrical power generator, for example, is a motor generator. The electrical power generator is driven by the engine, and thereby generates electrical power. The PDU is a converter including a switching element. By the switching element being controlled, the PDU converts the alternating current power generated by the electrical power generator into direct current power and outputs the direct current power.

When the internal combustion engine is started, by the switching element being controlled, the PDU converts the direct current power input to the PDU into three-phase alternating current power and outputs the three-phase alternating current power to the electrical power generator. In this case, the PDU functions as an inverter. The electrical power generator is operated by the three-phase alternating current power, and the electrical power generator starts the engine.

The power generating device 28 includes a smoothing capacitor 28a. The smoothing capacitor 28a is provided in the PDU. The power generating device 28 may also include various sensors such as a voltage sensor and the like, and various elements such as fuses, relays, breakers, diodes, transistors, resistors, coils, capacitors, and the like.

The power supply system 26 includes a first power storage device 30 and a second power storage device 31 as auxiliary power sources. The first power storage device 30 and the second power storage device 31 include batteries (not shown). The battery, for example, is a lithium ion battery. The first power storage device 30 and the second power storage device 31 may include various sensors such as a voltage sensor and the like, and various elements such as fuses, relays, breakers, diodes, transistors, resistors, coils, capacitors, and the like.

The power supply system 26 includes a first load device 32 and a second load device 34. The first load device 32 and the second load device 34 include the VTOL electric motors 20 and the cruise electric motors 24. The first load device 32 and the second load device 34 may include auxiliary devices such as an oil pump and a cooling water pump.

The first load device 32 and the second load device 34 each include a drive device (not shown). The drive device is an inverter including a switching element. By the switching element being controlled, the drive device converts direct current power input to the drive device into three-phase alternating current power and outputs the three-phase alternating current power to the VTOL electric motors 20 or the cruise electric motors 24.

The first load device 32 includes a smoothing capacitor 32a, and the second load device 34 includes a smoothing capacitor 34a. The smoothing capacitor 32a and the smoothing capacitor 34a are provided in the drive device. The first load device 32 and the second load device 34 may include various sensors such as a voltage sensor and the like, and various elements such as fuses, relays, breakers, diodes, transistors, resistors, coils, capacitors, and the like.

The power supply system 26 includes a power supply circuit 36. The power supply circuit 36 includes a first power transmission bus 38 and a second power transmission bus 40.

The direct current power output from the power generation device 28 and the direct current power output from the first power storage device 30 can be supplied to the first load device 32 through the first power transmission bus 38. The first power storage device 30 is provided in parallel with the power generation device 28. The direct current power output from the power generation device 28 and the direct current power output from the second power storage device 31 can be supplied to the second load device 34 through the second power transmission bus 40. The second power storage device 31 is provided in parallel with the power generation device 28.

The power supply circuit 36 includes a first disconnection device 42. The first disconnection device 42 includes a first disconnection unit 42a disposed only in the positive wire of the pair of wires composed of the positive wire and the negative wire of the first power transmission bus 38. The first disconnection unit 42a is, for example, a contactor. The first disconnection unit 42a may be a relay, a switching element, or the like. The first disconnection device 42 can disconnect the power generation device 28 from the first power transmission bus 38.

The power supply circuit 36 includes a first reverse flow prevention device 44. The first reverse flow prevention device 44 includes a first reverse flow prevention element 44a disposed only in the positive wire of the pair of wires of the first power transmission bus 38. The first reverse flow prevention element 44a is, for example, a diode. The first reverse flow prevention device 44 prevents the supply of electrical power from the first power storage device 30 to the power generation device 28.

The power supply circuit 36 includes a charging circuit 46. One end of the charging circuit 46 is connected to the first power transmission bus 38 at a position between the first disconnection device 42 and the first reverse flow prevention device 44. To a charging port 50 provided at the other end of the charging circuit 46, an external charging device 48 can be connected. The charging circuit 46 is connected to the second power transmission bus 40 via the first power transmission bus 38, but is not directly connected to the second power transmission bus 40.

The external charging device 48 is installed outside the moving object 10, such as on an apron, a hanger and the like. While the moving object 10 is parked on the ground, the external charging device 48 is connected to the charging port 50. The first power storage device 30 and the second power storage device 31 are charged by the external charging device 48.

The power supply circuit 36 includes a second disconnection device 52. The second disconnection device 52 includes a second disconnection unit 52a disposed only in the negative wire of the pair of wires composed of the positive wire and the negative wire of the charging circuit 46. The second disconnection unit 52a is, for example, a contactor. The second disconnection unit 52a may be a relay, a switching element, or the like. The second disconnection device 52 can disconnect the charging port 50 from the first power transmission bus 38.

The power supply circuit 36 includes a third disconnection device 54. The third disconnection device 54 includes a third disconnection unit 54a disposed only in the positive wire of the pair of wires composed of the positive wire and the negative wire of the second power transmission bus 40. The third disconnection unit 54a is, for example, a contactor. The third disconnection unit 54a may be a relay, a switching element, or the like. The third disconnection device 54 can disconnect the power generation device 28 from the second power transmission bus 40.

The power supply circuit 36 includes a second reverse flow prevention device 56. The second reverse flow prevention device 56 includes a second reverse flow prevention element 56a disposed only on the positive wire of the pair of wires of the second power transmission bus 40. The second reverse flow prevention element 56a is, for example, a diode. The second reverse flow prevention device 56 prevents the supply of electrical power from the second power storage device 31 to the power generation device 28.

The power supply circuit 36 includes a fourth disconnection device 58. The fourth disconnection device 58 can disconnect the first power storage device 30 from the first power transmission bus 38. The fourth disconnection device 58 may be provided with a preliminary charging circuit.

The power supply circuit 36 includes a fifth disconnection device 60. The fifth disconnection device 60 can disconnect the second power storage device 31 from the second power transmission bus 40. The fifth disconnection device 60 may be provided with a preliminary charging circuit.

When the external charging device 48 is connected to the charging port 50, the first disconnection device 42, the second disconnection device 52, the third disconnection device 54, the fourth disconnection device 58, and the fifth disconnection device 60 are disconnected, as shown in FIG. 2. As a result, the charging port 50 is disconnected from the smoothing capacitor 28a of the power generation device 28, the smoothing capacitor 32a of the first load device 32, the smoothing capacitor 34a of the second load device 34, the first power storage device 30, and the second power storage device 31. Thus, the external charging device 48 can be connected to the charging port 50 in a state where no voltage is applied to the positive terminal and the negative terminal of the charging port 50.

The second disconnection unit 52a of the second disconnection device 52 may be disposed only in the positive wire of the charging circuit 46. In this case, in the first disconnection device 42, the first disconnection unit 42a is disposed only in the negative wire of the first power transmission bus 38, and in the third disconnection device 54, the third disconnection unit 54a is disposed only in the negative wire of the second power transmission bus 40. Furthermore, in the first reverse flow prevention device 44, the first reverse flow prevention element 44a is disposed only in the negative wire of the first power transmission bus 38, and in the second reverse flow prevention device 56, the second reverse flow prevention element 56a is disposed only in the negative wire of the second power transmission bus 40.

### Power Supply Circuit of Comparative Example

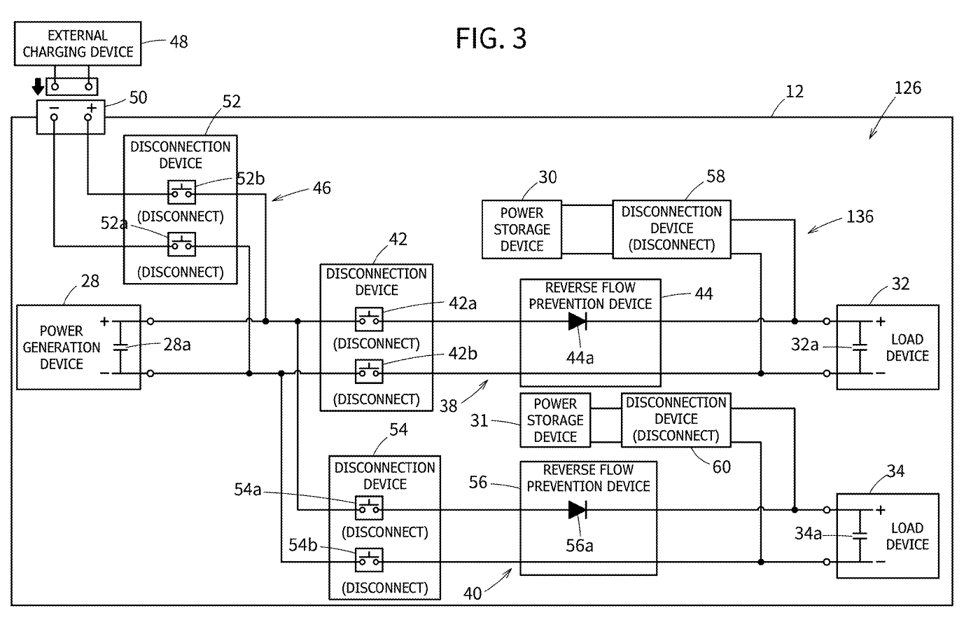

FIG. 3 is a schematic diagram of a power supply system 126 according to a first comparative example. In the power supply system 126 in the first comparative example, the configuration of a power supply circuit 136 is different from the configuration of the power supply circuit 36 of the power supply system 26 according to the embodiment shown in FIG. 2 in the following points.

In the power supply circuit 136 of the first comparative example, the first disconnection device 42 includes a first disconnection unit 42a disposed in the positive wire and a first disconnection unit 42b disposed in the negative wire of the first power transmission bus 38. Further, in the power supply circuit 136, the second disconnection device 52 includes a second disconnection unit 52b disposed in the positive wire and a second disconnection unit 52a disposed in the negative wire of the charging circuit 46. Further, in the power supply circuit 136, the third disconnection device 54 includes the third disconnection unit 54a disposed in the positive wire and a third disconnection unit 54b disposed in the negative wire of the second power transmission bus 40.

In the power supply circuit 136 of the first comparative example, the charging circuit 46 is connected to the first power transmission bus 38 at a position between the power generation device 28 and the first disconnection device 42 and between the power generation device 28 and the third disconnection device 54.

In the configuration of the first comparative example, each of the first disconnection device 42, the second disconnection device 52, and the third disconnection device 54 are provided with two disconnection units. Therefore, there are problems of increases in weight, size, and cost of the power supply circuit 136.

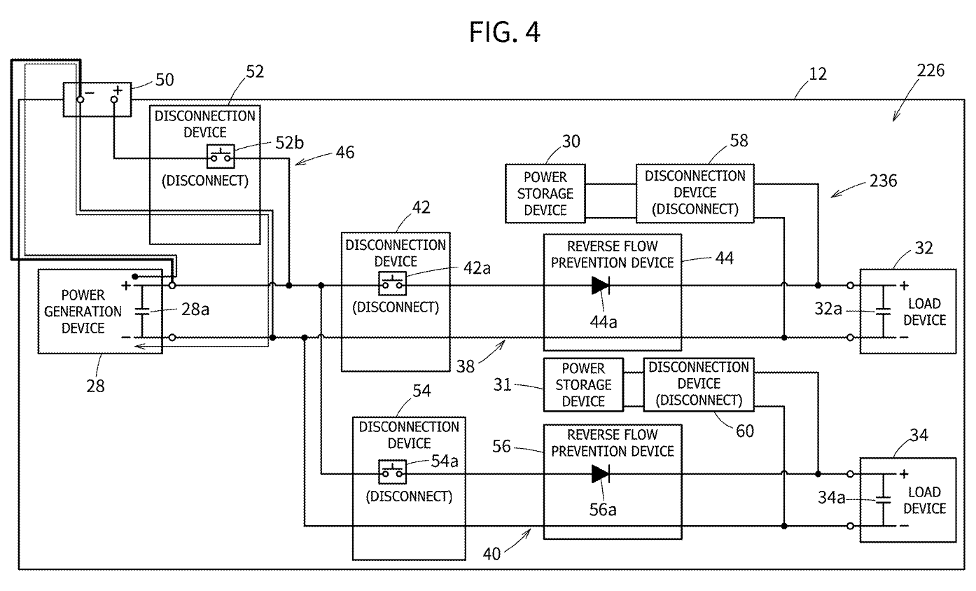

FIG. 4 is a schematic diagram illustrating a configuration of a power supply system 226 according to a second comparative example. In a power supply circuit 236 of the power supply system 226 according to the second comparative example, each of the first disconnection device 42, the second disconnection device 52, and the third disconnection device 54 includes a disconnection unit only in the positive wire.

Even in the configuration of the second comparative example, the charging port 50 can be normally disconnected from the smoothing capacitor 28a of the power generation device 28, the smoothing capacitor 32a of the first load device 32, the smoothing capacitor 34a of the second load device 34, the first power storage device 30, and the second power storage device 31.

As shown in FIG. 4, for example, in case where the negative terminal of the charging port 50 and the fuselage 12 are connected via a conductor and the positive terminal of the power generation device 28 and the fuselage 12 are connected via a conductor, the negative terminal of the charging port 50 and the positive terminal of the power generation device 28 are connected via the fuselage 12. In this case, even when the second disconnection unit 52b of the second disconnection device 52 is disconnected, a closed circuit including the power generation device 28 and the charging port 50 is formed, and the charging port 50 and the power generation device 28 are electrically connected.

In contrast, in the power supply circuit 36 of the embodiment, assuming that the first disconnection device 42, the second disconnection device 52, and the third disconnection device 54 are disconnected, the charging port 50 can be electrically disconnected from the power generation device 28, the first load device 32, and the second load device 34.

Hereinafter, the electrical disconnection between the charging port 50 and the power generation device 28, the first load device 32, and the second load device 34 will be described with reference to various examples.

### Charging Port Disconnection Function

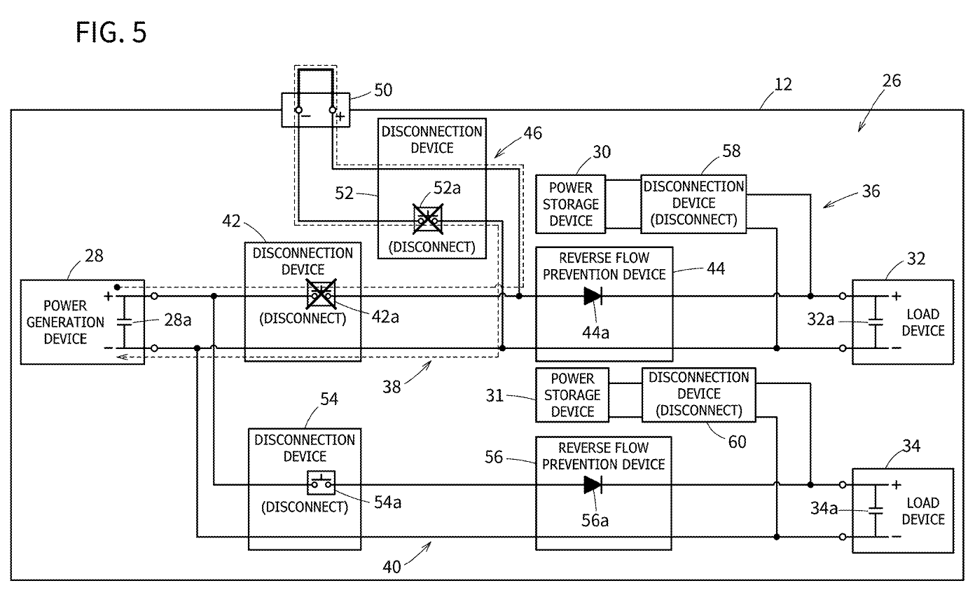

Connection between Positive Terminal and Negative Terminal of Charging Port FIGS. 5 to 7 are diagrams for explaining the function for disconnecting the charging port 50 of the power supply circuit 36 according to the embodiment. FIGS. 5 to 7 illustrate a state in which the positive terminal and the negative terminal of the charging port 50 are connected by a conductor.

In this case, as shown in FIG. 5, the charging port 50 and the power generation device 28 are electrically disconnected from each other by the first disconnection unit 42a of the first disconnection device 42 and the second disconnection unit 52a of the second disconnection device 52.

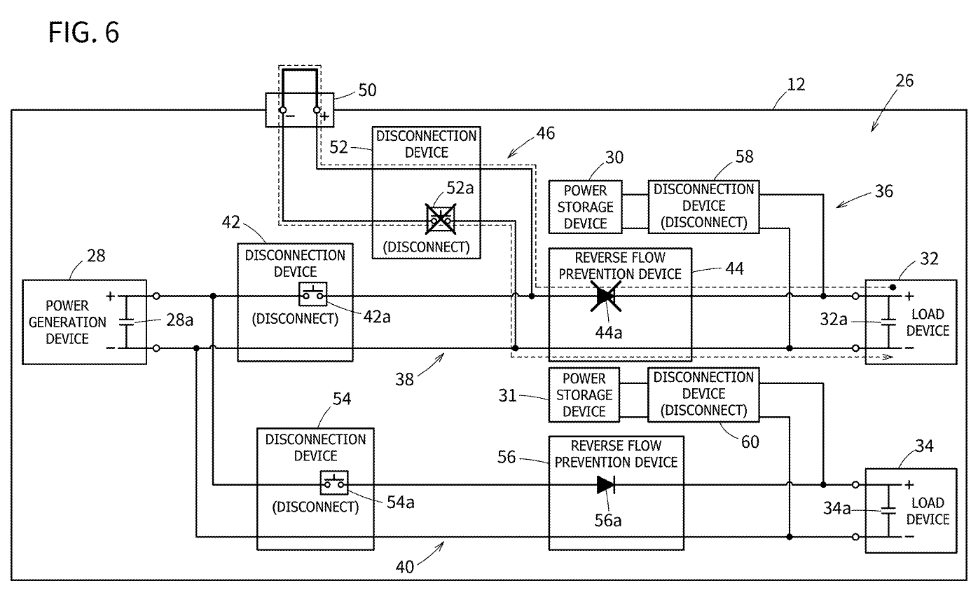

As shown in FIG. 6, the charging port 50 and the first load device 32 are electrically disconnected from each other by the second disconnection unit 52a of the second disconnection device 52 and the first reverse flow prevention element 44a of the first reverse flow prevention device 44.

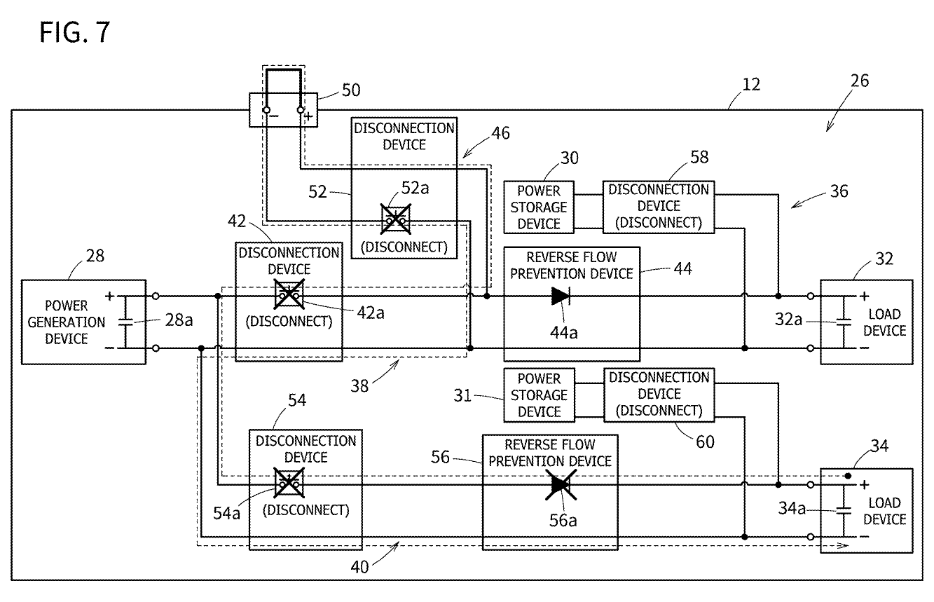

As shown in FIG. 7, the charging port 50 and the second load device 34 are electrically disconnected from each other by the first disconnection unit 42a of the first disconnection device 42, the second disconnection unit 52a of the second disconnection device 52, the third disconnection unit 54a of the third disconnection device 54, and the second reverse flow prevention element 56a of the second reverse flow prevention device 56.

### Connection between Negative Terminal of Charging Port and Positive Terminal of Power Generation Device

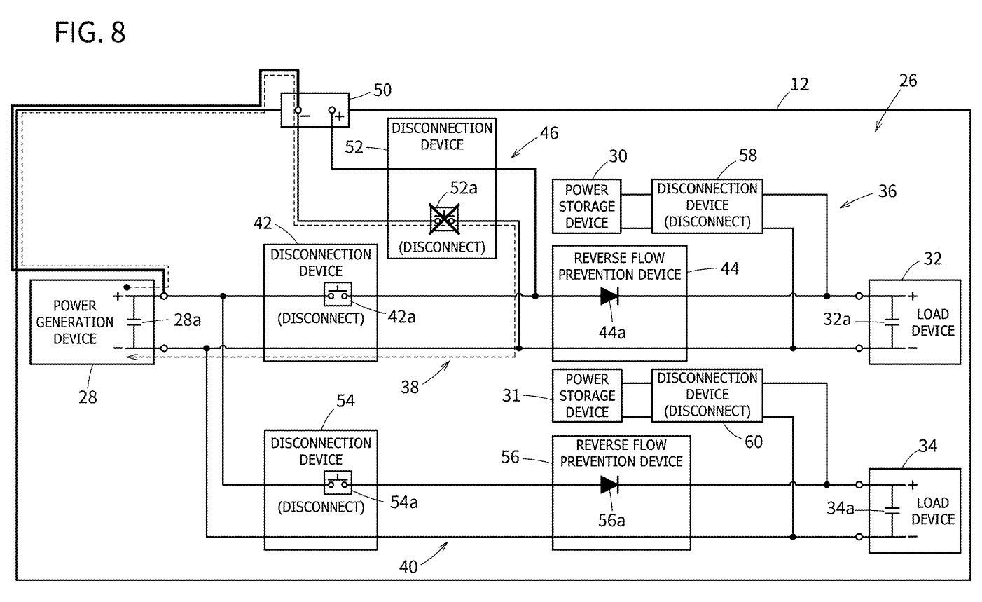

FIGS. 8 to 10 are diagrams for explaining the function for disconnecting the charging port 50 of the power supply circuit 36 according to the embodiment. FIGS. 8 to 10 illustrate a state in which the negative terminal of the charging port 50 and the fuselage 12 are connected by a conductor and the positive terminal of the power generation device 28 and the fuselage 12 are connected by a conductor, whereby the negative terminal of the charging port 50 and the positive terminal of the power generation device 28 are connected via the fuselage 12.

In this case, as shown in FIG. 8, the charging port 50 and the power generation device 28 are electrically disconnected from each other by the second disconnection unit 52a of the second disconnection device 52.

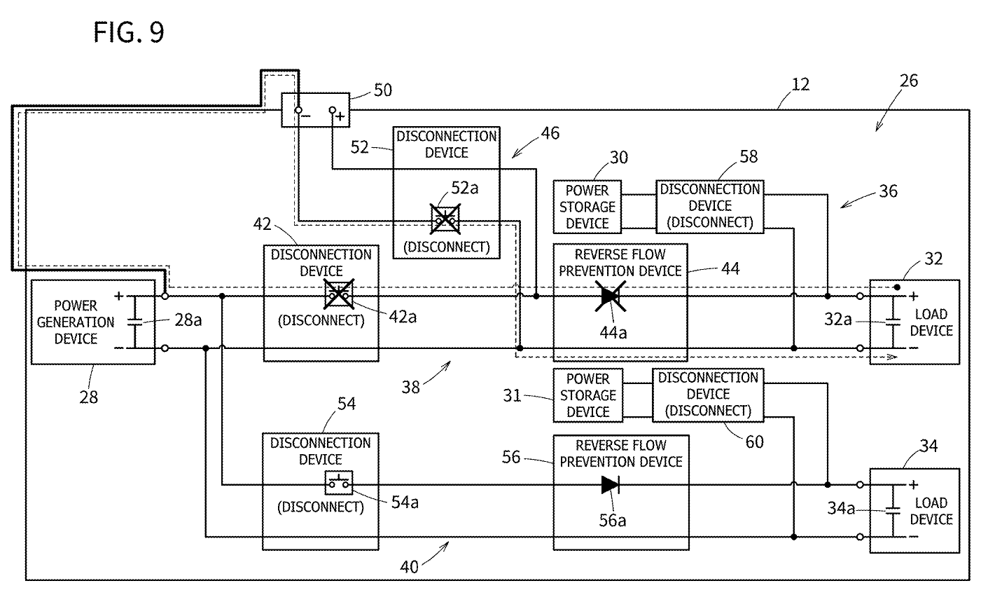

As shown in FIG. 9, the charging port 50 and the first load device 32 are electrically disconnected from each other by the first disconnection unit 42a of the first disconnection device 42, the second disconnection unit 52a of the second disconnection device 52, and the first reverse flow prevention element 44a of the first reverse flow prevention device 44.

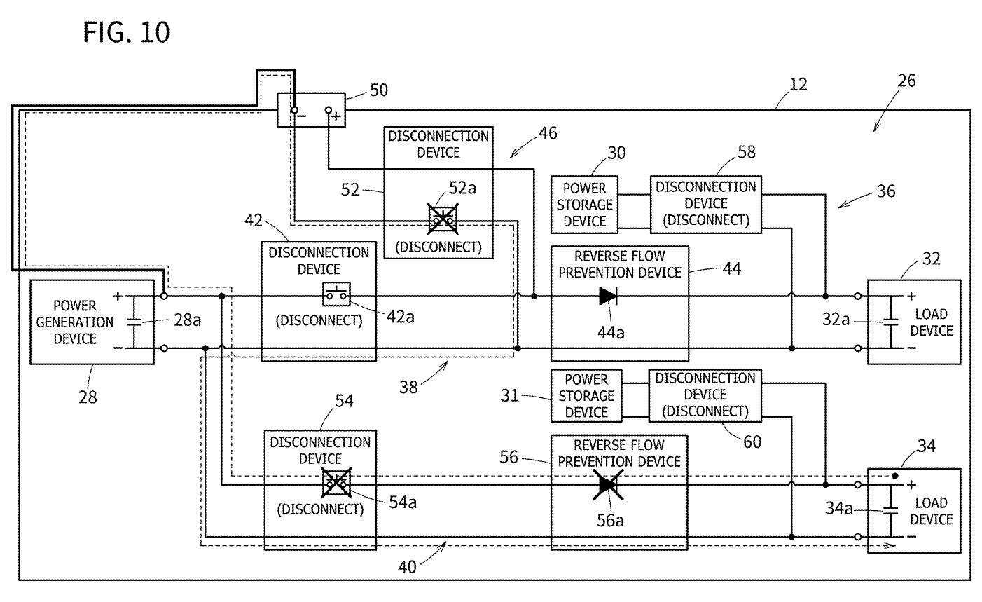

As shown in FIG. 10, the charging port 50 and the second load device 34 are electrically disconnected from each other by the second disconnection unit 52a of the second disconnection device 52, the third disconnection unit 54a of the third disconnection device 54, and the second reverse flow prevention element 56a of the second reverse flow prevention device 56.

### Connection between Positive Terminal of Charging Port and Negative Terminal of Power Generation Device

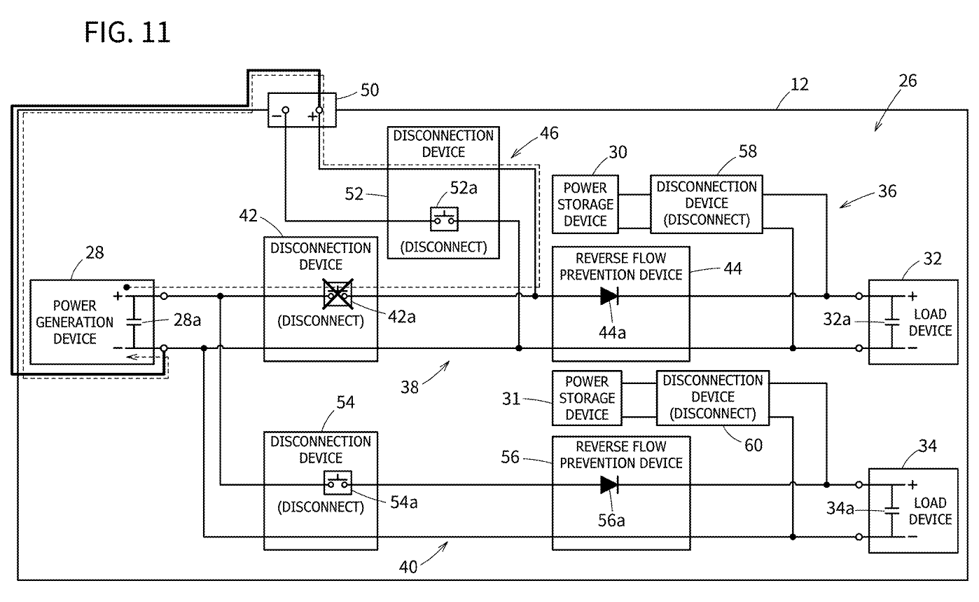

FIGS. 11 to 13 are diagrams for explaining the function for disconnecting the charging port 50 of the power supply circuit 36 according to the embodiment. FIGS. 11 to 13 illustrate a state in which the positive terminal of the charging port 50 and the fuselage 12 are connected by a conductor and the negative terminal of the power generation device 28 and the fuselage 12 are connected by a conductor, whereby the positive terminal of the charging port 50 and the negative terminal of the power generation device 28 are connected via the fuselage 12.

In this case, as shown in FIG. 11, the charging port 50 and the power generation device 28 are electrically disconnected from each other by the first disconnection unit 42a of the first disconnection device 42.

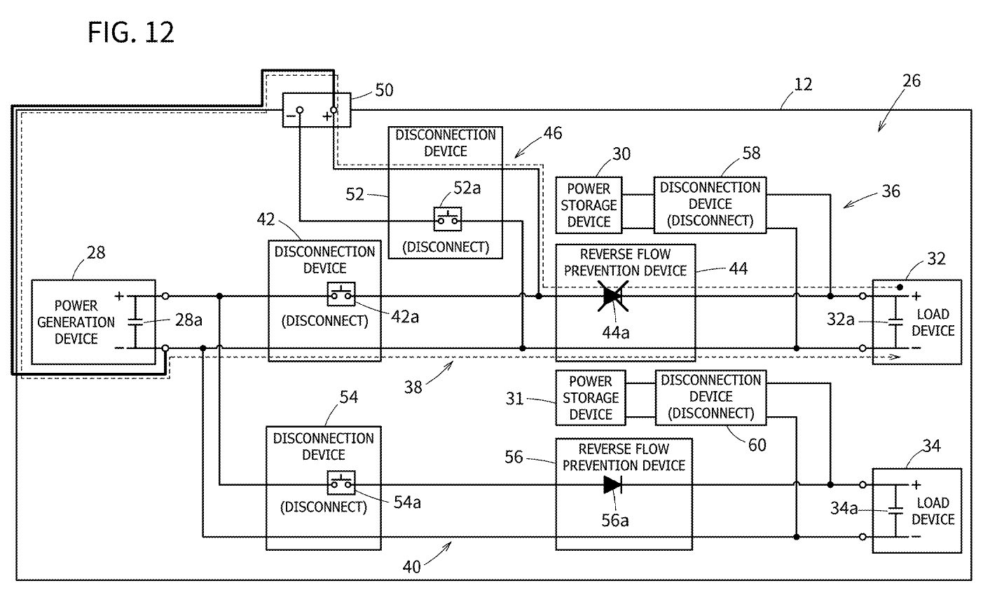

As shown in FIG. 12, the charging port 50 and the first load device 32 are electrically disconnected from each other by the first reverse flow prevention element 44a of the first reverse flow prevention device 44.

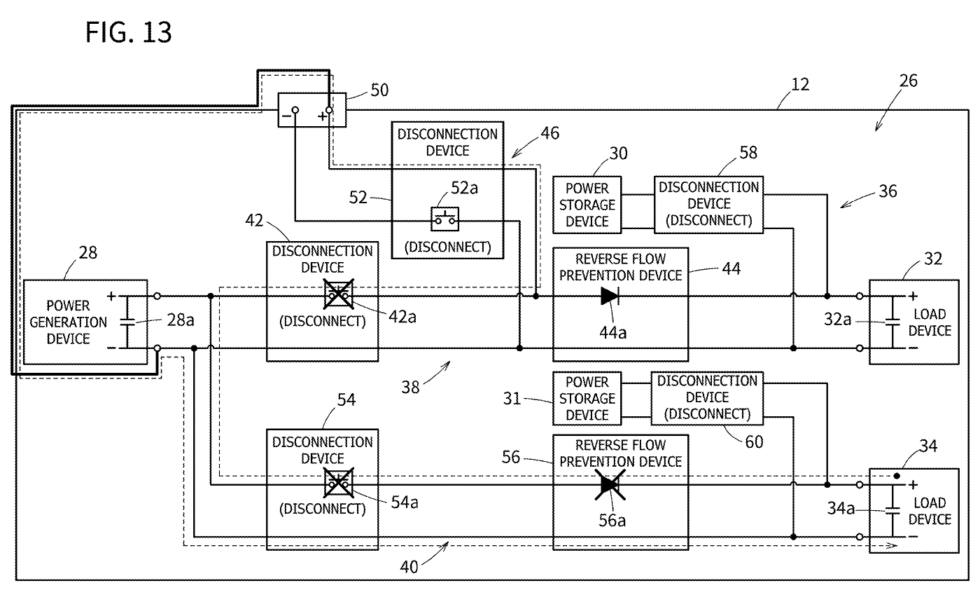

As shown in FIG. 13, the charging port 50 and the second load device 34 are electrically disconnected from each other by the first disconnection unit 42a of the first disconnection device 42, the third disconnection unit 54a of the third disconnection device 54, and the second reverse flow prevention element 56a of the second reverse flow prevention device 56.

### Connection between Negative Terminal of Charging Port and Positive Terminal of First Load Device

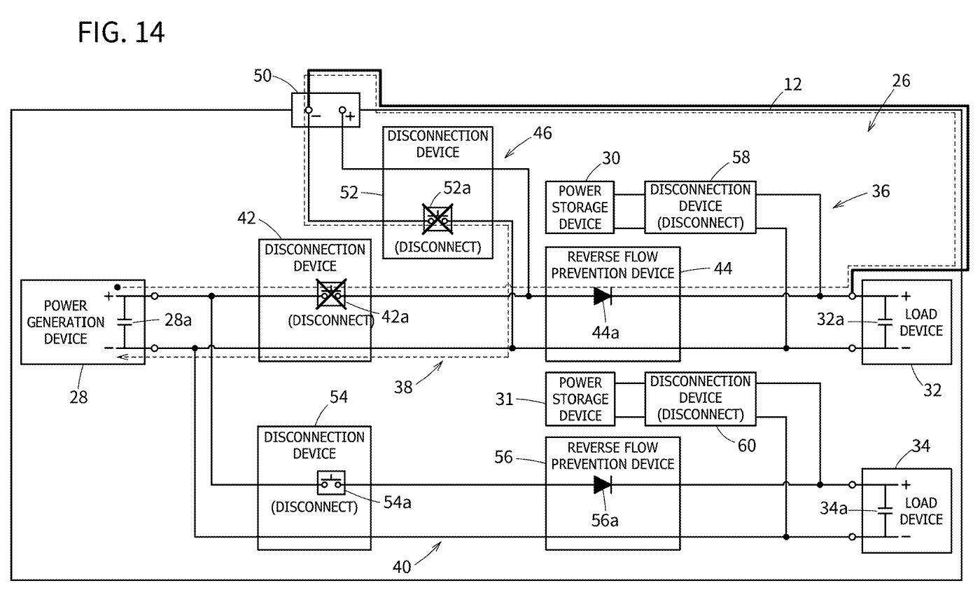

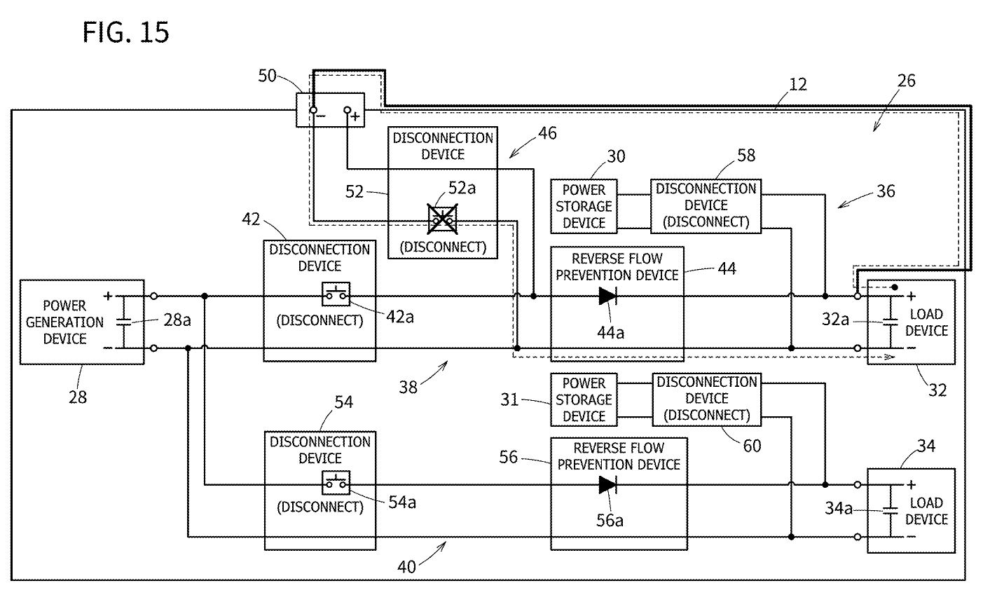

FIGS. 14 and 15 are diagrams for explaining the function for disconnecting the charging port 50 of the power supply circuit 36 according to the embodiment. FIGS. 14 and 15 illustrate a state in which the negative terminal of the charging port 50 and the fuselage 12 are connected by a conductor and the positive terminal of the first load device 32 and the fuselage 12 are connected by a conductor, whereby the negative terminal of the charging port 50 and the positive terminal of the first load device 32 are connected via the fuselage 12.

In this case, as shown in FIG. 14, the charging port 50 and the power generation device 28 are electrically disconnected from each other by the first disconnection unit 42a of the first disconnection device 42 and the second disconnection unit 52a of the second disconnection device 52.

As shown in FIG. 15, the charging port 50 and the first load device 32 are electrically disconnected from each other by the second disconnection unit 52a of the second disconnection device 52.

### Connection between Positive Terminal of Charging Port and Negative Terminal of First Load Device

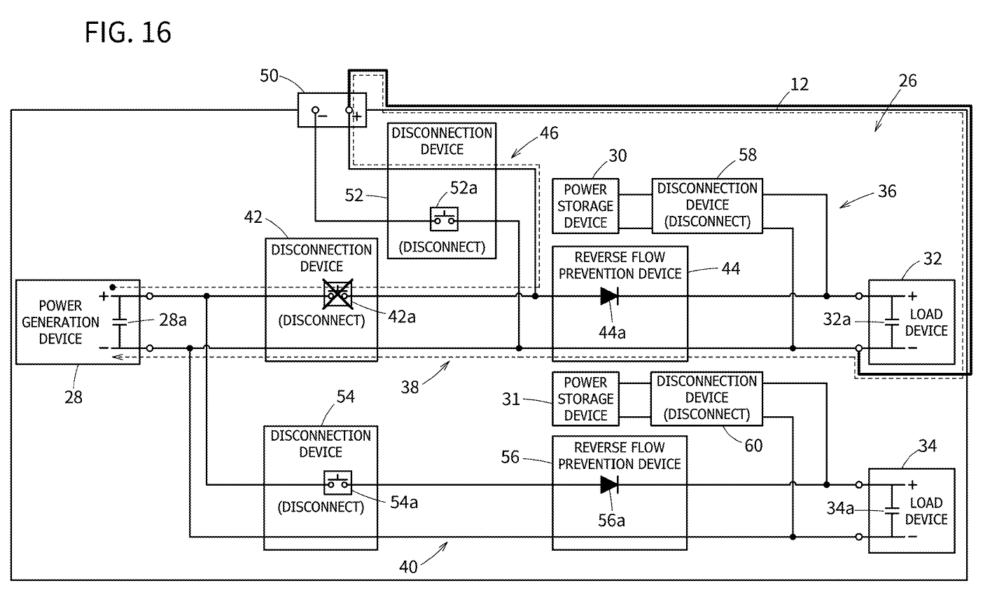

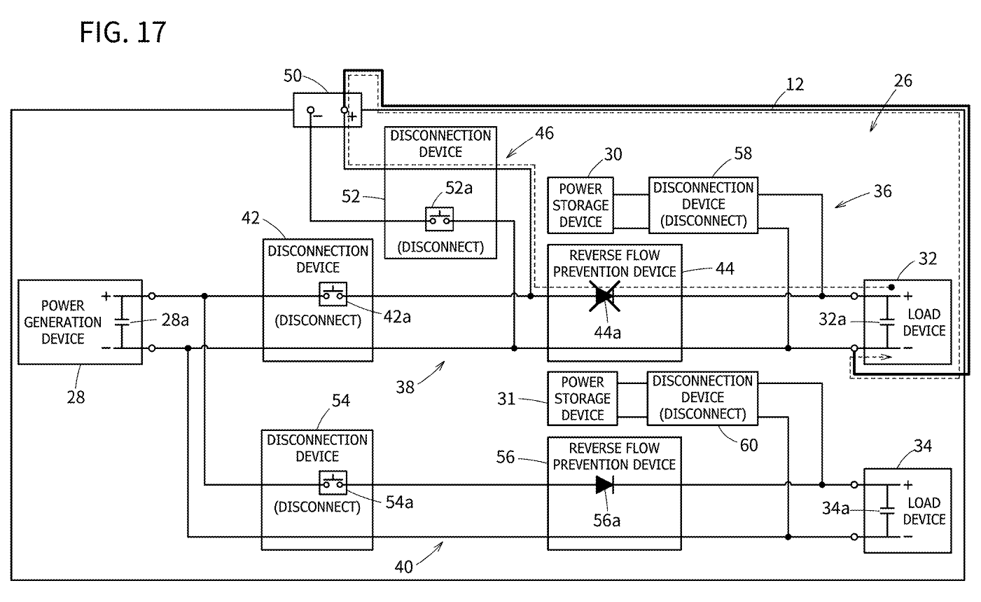

FIGS. 16 and 17 are diagrams for explaining the function for disconnecting the charging port 50 of the power supply circuit 36 according to the embodiment. FIGS. 16 and 17 illustrate a state in which the positive terminal of the charging port 50 and the fuselage 12 are connected by a conductor and the negative terminal of the first load device 32 and the fuselage 12 are connected by a conductor, whereby the positive terminal of the charging port 50 and the negative terminal of the first load device 32 are connected via the fuselage 12.

In this case, as shown in FIG. 16, the charging port 50 and the power generation device 28 are electrically disconnected from each other by the first disconnection unit 42a of the first disconnection device 42.

As shown in FIG. 17, the charging port 50 and the first load device 32 are electrically disconnected from each other by the first reverse flow prevention element 44a of the first reverse flow prevention device 44.

### Connection between Negative Terminal of Charging Port and Positive Terminal of Second Load Device

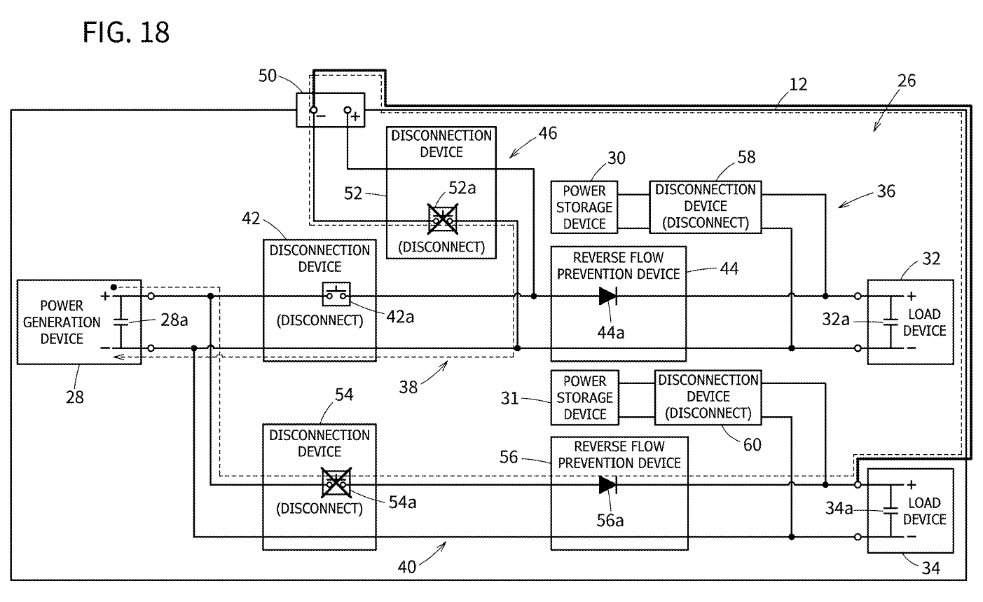

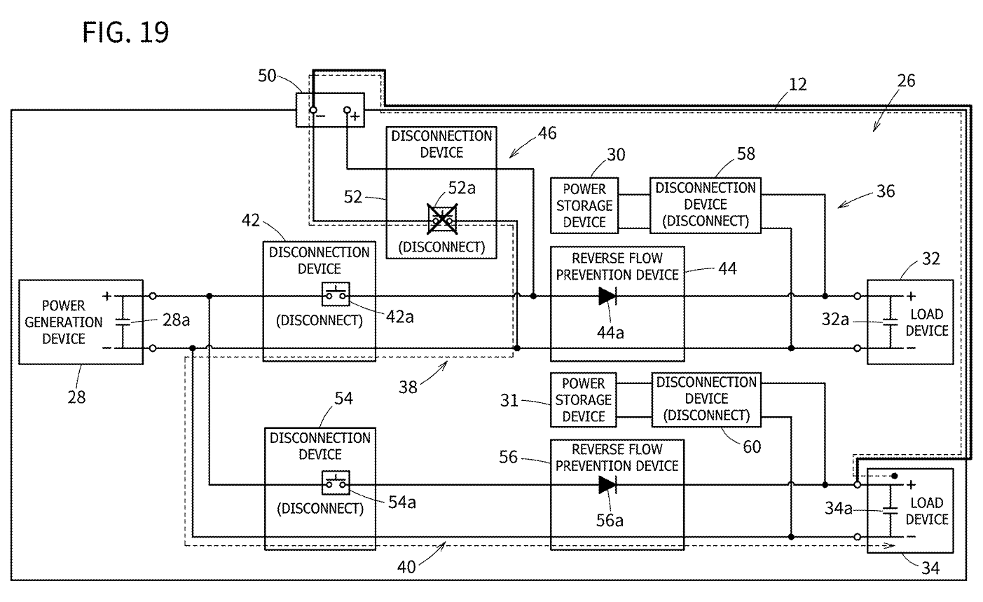

FIGS. 18 and 19 are diagrams for explaining the function for disconnecting the charging port 50 of the power supply circuit 36 according to the embodiment. FIGS. 18 and 19 illustrate a state in which the negative terminal of the charging port 50 and the fuselage 12 are connected by a conductor and the positive terminal of the second load device 34 and the fuselage 12 are connected by a conductor, whereby the negative terminal of the charging port 50 and the positive terminal of the second load device 34 are connected via the fuselage 12.

In this case, as shown in FIG. 18, the charging port 50 and the power generation device 28 are electrically disconnected from each other by the second disconnection unit 52a of the second disconnection device 52 and the third disconnection unit 54a of the third disconnection device 54.

As shown in FIG. 19, the charging port 50 and the second load device 34 are electrically disconnected from each other by the second disconnection unit 52a of the second disconnection device 52.

Connection between Positive Terminal of Charging Port and Negative Terminal of Second Load Device

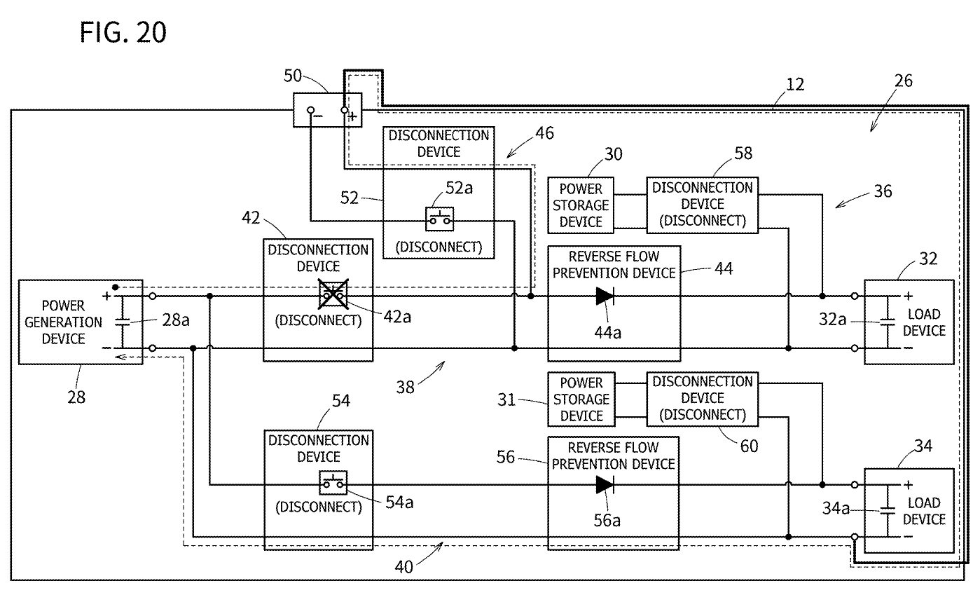

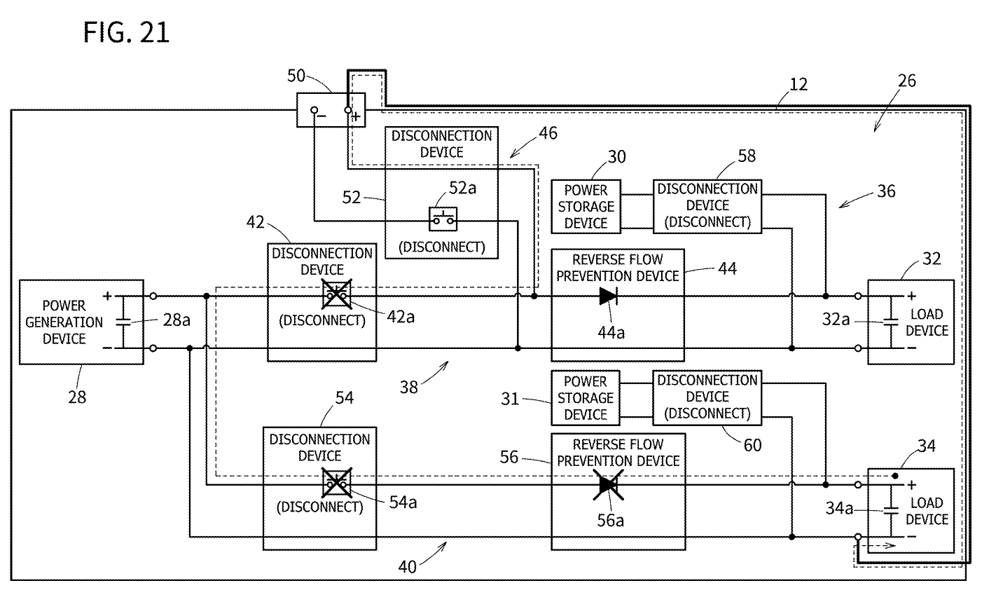

FIGS. 20 and 21 are diagrams for explaining the function for disconnecting the charging port 50 of the power supply circuit 36 according to the embodiment. FIGS. 20 and 21 illustrate a state in which the positive terminal of the charging port 50 and the fuselage 12 are connected by a conductor and the negative terminal of the second load device 34 and the fuselage 12 are connected by a conductor, whereby the positive terminal of the charging port 50 and the negative terminal of the second load device 34 are connected via the fuselage 12.

In this case, as shown in FIG. 20, the charging port 50 and the power generation device 28 are electrically disconnected from each other by the first disconnection unit 42a of the first disconnection device 42.

As shown in FIG. 21, the charging port 50 and the second load device 34 are electrically disconnected from each other by the first disconnection unit 42a of the first disconnection device 42, the third disconnection unit 54a of the third disconnection device 54, and the second reverse flow prevention element 56a of the second reverse flow prevention device 56.

In relation to the above-described disclosure, the following supplementary notes are further disclosed.

### Supplementary Note 1

The power supply circuit (36) including: the first power transmission bus (38) configured to supply, to the first load device (32), direct current power output from the power generation device (28) and direct current power output from the first power storage device (30) provided in parallel with the power generation device; the first disconnection device (42) configured to disconnect the power generation device from the first power transmission bus by the first disconnection unit (42a) disposed in only one of a pair of wires composed of a positive wire and a negative wire of the first power transmission bus, the first reverse flow prevention device (44) configured to prevent power from being supplied from the first power storage device to the first power generation device by the first reverse flow prevention element (44a) disposed in only the one of the pair of wires of the first power transmission bus; the charging circuit (46) having one end connected to the first power transmission bus at a position between the first disconnection device and the first reverse flow prevention device and another end connected to the charging port (50) connectable to the external charging device (48); and the second disconnection device (52) configured to disconnect the charging port from the first power transmission bus by the second disconnection unit (52a) disposed in only one of a pair of wires composed of a positive wire and a negative wire of the charging circuit, wherein the one of the pair of wires of the charging circuit in which the second disconnection unit is disposed is connected to another of the pair of wires of the first power transmission bus that is different from the one of the pair of wires of the first power transmission bus in which the first disconnection unit and the first reverse flow prevention element are disposed.

### Supplementary Note2

The power supply circuit according to Supplementary Note 1 may further include: the second power transmission bus (40) configured to supply, to the second load device (34), direct current power output from the power generation device and direct current power output from the second power storage device (31) provided in parallel with the power generation device; the third disconnection device (54) configured to disconnect the power generation device from the second power transmission bus by the third disconnection unit (54a) disposed in only one of a pair of wires composed of a positive wire and a negative wire of the second power transmission bus; the second reverse flow prevention device (56) configured to prevent power from being supplied from the second power storage device to the power generation device by the second reverse flow prevention element (56a) disposed in only the one of the pair of wires of the second power transmission bus, wherein the one of the pair of wires of the charging circuit in which the second disconnection unit is disposed may be connected to another of the pair of wires of the second power transmission bus that is different from the one of the pair of wires of the second power transmission bus in which the third disconnection unit and the second reverse flow prevention element are disposed.

### Supplementary Note 3

In the power supply circuit according to Supplementary Note 2, the charging circuit may be connected to the second power transmission bus via the first power transmission bus, and may not be directly connected to the second power transmission bus.

### Supplementary Note 4

The moving object (10) according to the present disclosure comprises the power supply circuit according to any one of Supplementary Notes 1 to 3.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A power supply circuit comprising:
a first power transmission bus configured to supply, to a first load device, direct current power output from a power generation device and direct current power output from a first power storage device provided in parallel with the power generation device;
a first disconnection device configured to disconnect the power generation device from the first power transmission bus by a first disconnection unit disposed in only one of a pair of wires composed of a positive wire and a negative wire of the first power transmission bus;
a first reverse flow prevention device configured to prevent power from being supplied from the first power storage device to the first power generation device by a first reverse flow prevention element disposed in only the one of the pair of wires of the first power transmission bus;
a charging circuit having one end connected to the first power transmission bus at a position between the first disconnection device and the first reverse flow prevention device and another end connected to a charging port connectable to an external charging device; and
a second disconnection device configured to disconnect the charging port from the first power transmission bus by a second disconnection unit disposed in only one of a pair of wires composed of a positive wire and a negative wire of the charging circuit, wherein
the one of the pair of wires of the charging circuit in which the second disconnection unit is disposed is connected to another of the pair of wires of the first power transmission bus that is different from the one of the pair of wires of the first power transmission bus in which the first disconnection unit and the first reverse flow prevention element are disposed.

2. The power supply circuit according to claim 1, further comprising:
a second power transmission bus configured to supply, to a second load device, direct current power output from the power generation device and direct current power output from a second power storage device provided in parallel with the power generation device;
a third disconnection device configured to disconnect the power generation device from the second power transmission bus by a third disconnection unit disposed in only one of a pair of wires composed of a positive wire and a negative wire of the second power transmission bus;
a second reverse flow prevention device configured to prevent power from being supplied from the second power storage device to the power generation device by a second reverse flow prevention element disposed in only the one of the pair of wires of the second power transmission bus, wherein
the one of the pair of wires of the charging circuit in which the second disconnection unit is disposed is connected to another of the pair of wires of the second power transmission bus that is different from the one of the pair of wires of the second power transmission bus in which the third disconnection unit and the second reverse flow prevention element are disposed.

3. The power supply circuit according to claim 2, wherein the charging circuit is connected to the second power transmission bus via the first power transmission bus, and is not directly connected to the second power transmission bus.

4. A moving object comprising the power supply circuit according to claim 1.
